(19) United States
(12) Patent Application Publication
(10) Pub. No.: US 2018/0125099 A1
(43) Pub. Date: May 10, 2018

(54) DEVICE FOR DISPENSING, INFUSING, AND AGITATING SOLUBLE CONSUMABLES IN WATER

(71) Applicant: HAKAM SAMARAIE, ANN ARBOR, MI (US)

(72) Inventor: HAKAM SAMARAIE, ANN ARBOR, MI (US)

(21) Appl. No.: 15/347,732

(22) Filed: Nov. 9, 2016

(51) Int. Cl. A23L 2/56; A47J 43/27

(52) U.S. Cl. CPC A23L 2/56; A23V 2002/00; A47J 43/27

(57) ABSTRACT

The present invention is a tube with perforations in which a dried consumable, such as coffee and tea, is contained. The device for dispensing, infusing, and agitating a soluble consumable in water is placed in hot water, where the consumable is dispensed and infused into the water. The user can use the tube to stir the water, increasing the concentration of the consumable, such as coffee or tea, in the water. The tube is constructed from a lamination of two materials, wherein the outer layer has a larger Young's Modulus than the inner layer. The outer layer is perforated. The inner layer has slits that align with the perforations in the outer layer.

### FIELD OF INVENTION

This invention relates to the classifications for food or edible materials, and their process, compositions, and products. Specifically, this invention relates to devices to infuse consumables using foraminous material.

### BACKGROUND OF INVENTION

Coffee and tea are nearly ubiquitous beverages. For example, the coffee market in the U.S. is estimated at $48 Billions in 2015 according to the Specialty Coffee Association of America. In 2015, the U.S. tea market was estimated at almost $3 Billion by the Tea Association of the USA. Although smaller than the coffee market in the U.S., the tea market is huge, worldwide with annual sales of tea approaching $38 Billion, worldwide, in 2016. With increased immigration into the U.S. from the middle east and south Asia, the number of tea drinkers in the U.S. is going up.

As the demand for coffee and tea increases, there are expanding markets for products and services for coffee and tea drinkers. For example, there are many variations of the single serving pouch or product that allows a person to brew one cup of tea or coffee. People like using things like tea bags or instant coffee at work, or at home if they are the only person who consumes coffee and tea. One of the problems with tea bags, and with instant coffee, is that it requires a spoon in order to properly stir it. Another problem with tea bags and instant coffee are that they make a reliable small mess each time a new cup is served. With tea, the tea bag must be removed and properly disposed of. With instant coffee, the spoon, covered in coffee, must be removed from the cup. Disposable stirrers and swivel sticks don't really solve the problem of the mess, and they don't really meet the market need. What the both the coffee and tea market are looking for is an integrated device that could be used to dispense, infuse, and agitate a single cup of coffee or tea, reliably and without mess. For such a device, it is important that the user can continually stir or otherwise agitate the device until the coffee or tea is the correct strength or concentration.

### REVIEW OF THE PRIOR ART

The inventions reviewed, below, are in addition to the well-known tea bags, instant coffee, and K-cup® that are in current use in the market. The current prior art has not established a device for dispensing, infusing and agitating a single cup of coffee or tea. Several attempts have been made, but all seem to have a rather significant drawback.

For example, U.S. Utility Pat. No. 5,866,185 by named inventor Burkett, entitled, “Method and device for dispensing an ingestible soluble material for further dissolving in a liquid” (“Burkett 185”), teaches a cylindrical tube with perforations that contains tea or coffee. The exterior of the tube is coated with sugar or Nutrasweet® in order to keep the tea or coffee from escaping prior to use. The cylindrical shape allows the device to be used to stir the liquid to agitate the consumable and infuse it into the water. The drawback with Burkett '185 is that it requires the use of sugar or other coating in order to keep the coffee or tea in the device. Not everyone wants sweetened coffee or tea. Additionally, using a sweetener as the exterior coating keeping the consumable within the packaging makes the invention susceptible to contamination if it inadvertently gets wet before use.

U.S. Utility Pat. No. 6,541,055 by named inventor Luzenberg entitled, “Porous plastic dispensing article” (“Luzenberg 055”), teaches a device which attaches to a spigot and flavors water. The device is tubular, preferably made out of polyethylene or polypropylene, allowing the flavored water to come out of pores between 20 and 200 microns. Luzenberg '055 doesn't solve a problem for coffee and tea drinkers because it is not really practical for use with boiling water, and it does not allow for stirring in order to get the liquid the correct concentration.

U.S. Utility Pat. No. 5,076,425 by named inventor Plone entitled, “Dispensing stick for dispensing substance into a container combined with dispensing lid” (“Pline '625”), teaches a stick with porous walls to dispense tea into a liquid. Other prior art exists, but it is merely cumulative in that it does not really meet the market need.

### SUMMARY OF THE INVENTION

The present invention improves and expands on the prior art. The present invention is a device for dispensing, infusing, and agitating a soluble consumable, such as coffee or tea, in water.

The present invention is a tube with perforations in which a dried consumable, such as coffee and tea, is contained. The device for dispensing, infusing, and agitating a soluble consumable in water is placed in hot water, where the consumable is dispensed and infused into the water. The user can use the tube to stir the water, increasing the concentration of the consumable, such as coffee or tea, in the water.

The tube is constructed from a lamination. The lamination can be fabricated from at least two layers of material. The outer layer of material is relatively more rigid and does not plasticize at less than 100° C. The inner layer is relatively less rigid and may plasticize at less than 100° C., preferably around 75° C. In other words, the Young's Modulus of the outer layer is greater than the Young's Modulus of the inner layer, both at room temperature and at 100° C. The outer layer may be fabricated from aluminum foil, tin foil, metal alloy foil, low-density polyethylene (“LDPE”), polypropylene (“PP”), high-density polyethylene (“HDPE”), polyvinylidene chloride (“PVDC”), polystyrene (“PS”), or polyethylene terephthalate (“PET”). The inner layer may be fabricated from aluminum foil, tin foil, metal alloy foil, LDPE, PP, HDPE, PVDC, PC, or PET. The preferred materials for the outer layer are aluminum foil or HDPE. The preferred materials for the inner layer are LDPE or PVDC.

The outer layer has perforations on a portion that will correspond to the bottom half of the present invention. Approximately one-half of the height of the outer layer of the lamination is perforated with a plurality of holes. The inner layer has slits on a portion that will correspond to the bottom half of the present invention. The slits and perforations are aligned. There are the same number of perforations as slits. The perforations should have a diameter no smaller than 0.05 mm and no larger than 5 mm. The slits should have a length equal to the diameter of the perforations. The materials are cut to make devices between 75 mm and 150 mm in height.

A tube is formed from the laminated material. The bottom of the tube has the perforations and slits. At the very bottom of the tube is the footer, a portion of the laminate without perforations or slits. The bottom of the tube or footer is sealed using heat staking, heat sealing, over-molding, or adhering. This operation creates a bottom crimp. The tube is filled to above the highest perforation with a dried consumable that will infuse hot water, such as coffee or tea. The dried consumable is compacted. A pressurized gas, such as air, may be added to the top of the dried consumable. The top of the tube is then sealed using heat staking, heat sealing, over-molding, or adhering. The present invention is ready to use.

By inserting the present invention into a cup of hot water, the water permeates the inside of the tube through the perforations and slits. The water carries some of the soluble consumable back out of the present invention. The user can use the present invention like a stirrer. The more agitation or stirring, the more soluble consumable is infused into the water.

### BRIEF DESCRIPTION OF THE DRAWINGS

The present invention is illustrated with five drawings on two sheets.

FIG. 1 is an isometric front view of the present invention in mid-fabrication.

FIG. 2 is a lateral isolation view of dried consumable in the present invention.

FIG. 3 is a lateral view of the present invention.

FIG. 4 is an isolation of the lamination used to fabricate the tube of the present invention.

FIG. 5 is an isolation of the inner layer of the lamination used to fabricate the tube of the present invention.

### DESCRIPTION OF EMBODIMENT

The following descriptions are not meant to limit the invention, but rather to add to the summary of invention, and illustrate the present invention, by offering and illustrating various embodiments of a device for dispensing, infusing, and agitating a soluble consumable in water. While embodiments of the invention are illustrated and described, the embodiments herein do not represent all possible forms of the invention. Rather, the descriptions, illustrations, and embodiments are intended to teach and inform without limiting the scope of the invention.

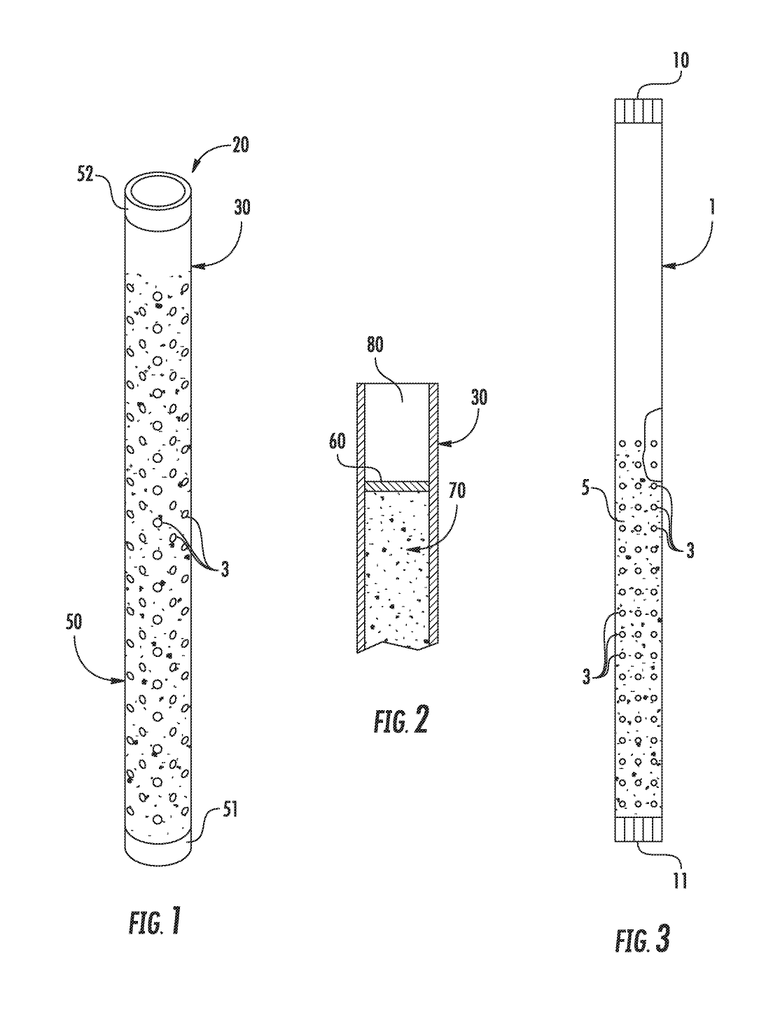

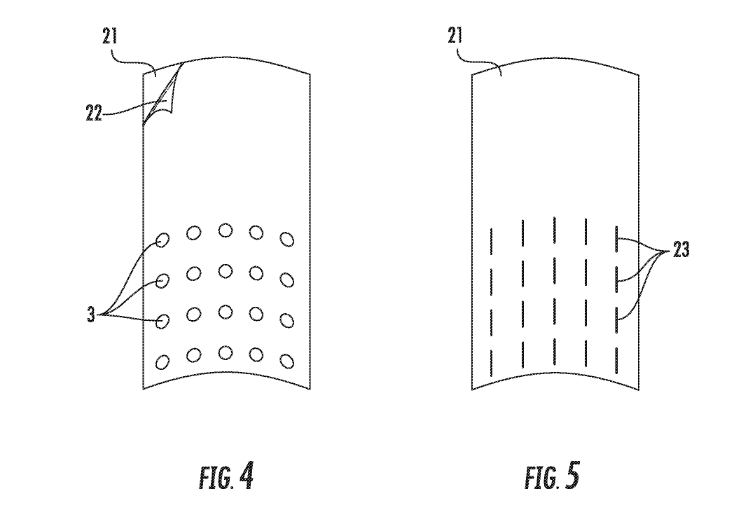

FIGS. 1-3 show various aspects of the present invention, a device for dispensing, infusing, and agitating a soluble consumable in water 1. FIG. 3 is a lateral view of the present invention 1. The device for dispensing, infusing, and agitating a soluble consumable in water 1 has a top crimp 10, a bottom crimp 11, and a cylindrical surface 5 with a plurality of perforation holes 3.

The device for dispensing, infusing, and agitating a soluble consumable in water 1 is constructed by making a tube 20 as shown in FIG. 1. The tube 20 has an upper surface 30 without perforations, a lower surface 50 with perforations 3. The tube 20 has a header 52 that will become the top crimp using heat staking, heat sealing, over-molding, or adhering. The tube 20 has a footer 51 that will become the bottom crimp 11 using heat staking, heat sealing, over-molding, or adhering.

FIGS. 4 and 5 show the material from which the tube 20 is fabricated. The tube 20 is made out of a laminated material 21, 22. The laminated material has an outer layer 22 and an inner layer 21. The outer layer 22 has a plurality of holes 3. The diameter of the holes can range from 50 microns (0.5 mm) to 5 mm, depending on the infusible consumable used, and the material of the inner layer 21. The inner layer 21 has a plurality of slits 23. The slits 23 are aligned during fabrication with the holes 3. The outer layer 22 is made from any one of a variety of thin sheet materials such as aluminum foil, tin foil, metal alloy foil, LDPE, PP, HDPE, PVDC, PS, or PET. The inner layer 21 is made from any one of a variety of thin sheet materials such as aluminum foil, tin foil, metal alloy foil, LDPE, PP, HDPE, PVDC, PS, or PET. From a practical standpoint, the outer layer 22 should be made from a relatively stiffer material such as aluminum foil, tin foil, metal alloy foil, HDPE, PS, or PET. From a practical standpoint, the outer layer should be made from aluminum foil or HDPE, as PET and PS have been related to health concerns. The inner layer 21 should be made from a softer material such as LDPE or PVDC. From a practical standpoint, LDPE is a preferable material because of concerns with heated PVDC. The inner layer 21 is relatively less rigid than the outer layer 22, and may plasticize at less than 100° C., preferably around 75° C.

The tube 20 in FIG. 1 is constructed from the laminated material 21, 22. Using heat staking, heat sealing, over-molding, or adhering, the footer 51 is formed into the bottom crimp 11. The dried, infusible consumable 70 is packed into the tube 20 up to the fill line 60. The dried, infusible consumable 70 must be compacted to achieve best results. The fill line 60 is above the perforations 3. The fill line 60, optionally, can have a physical barrier (not shown) placed on top. Once the tube 20 is filled with dried, infusible consumable 70, a gas 80, such as air, pressurizes the top of the tube, and the header 52 is formed into the top crimp 10.

In use, the present invention 1 will infuse the consumable 70, such as coffee or tea, into a cup of hot water. Due to the compacted nature of the consumable 70, the lamination 21, 22 of the tube 20 material, and the pressurized gas, the tube 20 will remain rigid, allowing the beverage to be stirred in order to achieve the desired concentration of the consumable 70. The slits 23 in the inner layer 21 keep the consumable in the tube 20. When the present invention 1 is placed in a hot cup of water, the inner layer 21 softens. When the present invention 1 is stirred in the cup of water, agitating the water, the slits 23 in the inner layer 21 allow for liquid to enter and exit the tube, infusing the beverage.

I claim:

1. A device for dispensing, infusing, and agitating a soluble consumable in water comprising
a laminated tube having a substantially cylindrical surface with a top portion, a bottom portion, an inner surface and an outer surface; a top crimp, and a bottom crimp;
wherein the lamination includes at least an outer layer and an inner layer;
wherein the outer layer makes up the outer cylindrical surface; and wherein the lower portion of the outer cylindrical surface has a plurality of perforations;
wherein the inner layer makes up the inner cylindrical surface; and wherein the lower portion of the inner cylindrical surface has the same number of slits, as the outer cylindrical surface has perforations,
wherein the slits and perforations are aligned with one another, layer-to-layer;
a dried infusible consumable contained within the laminated tube, filling the laminated tube to a fill line that is above the upper most perforation, wherein the dried infusible consumable is compacted into the laminated tube;
wherein the filled tube is sufficiently rigid to stir hot water, allowing the infusible consumable to infuse the hot water.

2. The device for dispensing, infusing, and agitating a soluble consumable in water in claim 1, wherein the Young's Modulus of the outer layer is greater than the Young's Modulus of the inner layer.

3. The device for dispensing, infusing, and agitating a soluble consumable in water in claim 2, wherein the inner layer plasticizes at temperatures above 75° C.

4. The device for dispensing, infusing, and agitating a soluble consumable in water in claim 3, wherein the outer layer is fabricated from at least one of aluminum foil, tin foil, metal alloy foil, low-density polyethylene (“LDPE”), polypropylene (“PP”), high-density polyethylene (“HDPE”), polyvinylidene chloride (“PVDC”), polystyrene (“PS”), or polyethylene terephthalate (“PET”).

5. The device for dispensing, infusing, and agitating a soluble consumable in water in claim 4, wherein the inner layer is fabricated from at least one of aluminum foil, tin foil, metal alloy foil, LDPE, PP, HDPE, PVDC, PS, or PET.

6. The device for dispensing, infusing, and agitating a soluble consumable in water in claim 5, wherein the outer layer is fabricated from aluminum foil and the inner layer is fabricated from LDPE.

7. The device for dispensing, infusing, and agitating a soluble consumable in water in claim 5, wherein the outer layer is fabricated from HDPE and the inner layer is fabricated from LDPE.

8. The device for dispensing, infusing, and agitating a soluble consumable in water in claim 5, wherein the outer layer is fabricated from aluminum foil and the inner layer is fabricated from PVDC.

9. The device for dispensing, infusing, and agitating a soluble consumable in water in claim 1, wherein the perforations have a diameter between 0.5 mm and 5 mm.

10. The device for dispensing, infusing, and agitating a soluble consumable in water in claim 8, wherein the slits have a length equal to the diameter of the perforations.

11. The device for dispensing, infusing, and agitating a soluble consumable in water in claim 1, wherein the tube is filled above the fill line with a pressurized gas.

12. The device for dispensing, infusing, and agitating a soluble consumable in water in claim 11, wherein the pressurized gas is air.

13. The device for dispensing, infusing, and agitating a soluble consumable in water in claim 1 wherein the infusible consumable is ground coffee.

14. The device for dispensing, infusing, and agitating a soluble consumable in water in claim 1 where the infusible consumable is instant coffee.

15. The device for dispensing, infusing, and agitating a soluble consumable in water in claim 1 where the infusible consumable is tea.

16. The device for dispensing, infusing, and agitating a soluble consumable in water in claim 1 wherein the length of time the filled tube stirs the hot water is proportional to the concentration of the infusible consumable that is infused into the hot water.
